(19) United States
(12) Patent Application Publication
(10) Pub. No.: US 2024/0324519 A1
(43) Pub. Date: Oct. 3, 2024

(54) VERTICAL FARMING POLYHOUSE STRUCTURE

(71) Applicants: Rajesh Ram EDKE, Pune (IN); Sunanda Ram EDKE, Pune (IN)

(72) Inventors: Rajesh Ram EDKE, Pune (IN); Sunanda Ram EDKE, Pune (IN)

(21) Appl. No.: 18/621,846

(22) Filed: Mar. 29, 2024

(30) Foreign Application Priority Data
Mar. 30, 2023 (IN) 202321023726

(51) Int. Cl. A01G 9/02; A01G 7/06; A01G 9/18; A01G 9/24; A01G 9/26; A01M 13/00; A01M 21/04

(52) U.S. Cl. CPC A01G 9/023; A01G 7/06; A01G 9/18; A01G 9/247; A01G 9/249; A01M 13/00; A01M 21/043; A01G 9/26

(57) ABSTRACT

With increasing population and pollution land availability for farming is reducing each day. To address this problem the present invention provides A polyhouse structure including a plurality of vertical towers supporting polyhouse roof. Further, a vertical tower of the plurality of vertical towers includes at least one bamboo. Further, the at least one bamboo is configured to hold a plurality of grow cups. Further, at least one composite member is formed by inserting and fixing at least one rod to at least one end of the at least one bamboo. Further, at least one composite member is rotatable, and an upper end of the composite member fixed to an anchor and a lower end of the composite member is fixed on a mounting surface via the at least one bearing.

### TECHNICAL FIELD

The present subject matter described herein, in general, relates to a field of a systems for agricultural and horticulture. More particularly, the present subject matter relates to a vertical farming polyhouse structure for growing multiple saplings in a controlled environment.

### BACKGROUND

The technology of farming and agriculture has evolved over the time. But with increasing pressure on land, water and other resources, farming is becoming difficult and less remunerative. To solve this problem polyhouses are designed. Polyhouse construction is a well-proven method and process, which enables intensive and scientific farming. The polyhouses have controlled environment. Further, in the polyhouses integrated farming can be operationalized. In integrated farming various types of vegetables or cereals can be grow simultaneously. Further, such integrated farming is useful in floriculture, horticulture, or any other type of agricultural activity.

Nowadays in the polyhouses comprises polyhouse structure for vertical farming. Vertical farming saves the space and also allows optimal utilization of resources. However, the problem with vertical farming may be that most of the time the structures used for growing the saplings are exposed to inaccurate amount of the resources. Which compromise with the quality of the product. Further, the amount of sunlight may not be equally distributed. To solve this problem additional lighting polyhouse structures may be required. However, that increases the cost of operation and also natural growth cycle of saplings is also hampered.

The size of polyhouse varies from five hundred square meters to hectares. Bamboo based structures used for growing the saplings, large enough to grow crops under partial or fully controlled environmental conditions to get maximum productivity and quality produce. They are lighter in weight, sturdier, cheap and easy for installation.

Another problem with the polyhouses may be that permanent growing area which may be fixed. The fixed vertical faming increases the cost of transportation as each of the growing cup needs to be separated from the permanent stand.

Further, in fixed vertical farming the saplings may not be exposed to equal amount of sunlight. Which also create unequal quality of product resulting into less remunerative harvest for the farmer.

To solve the above problem a portable and rotatable vertical farming apparatus should be designed which can be easily removed from the polyhouse as per requirement.

### SUMMARY

This summary is provided to introduce the concepts related to a polyhouse structure for growing multiple saplings and the concepts may be further described in the detail description. This summary is not intended to identify essential features of the claimed subject matter nor it is intended to use in determining or limiting the scope of claimed subject matter.

In one embodiment, a polyhouse structure may comprise a plurality of vertical towers configured to support polyhouse member. A vertical tower of the plurality of vertical towers comprises at least one bamboo, at least one rod and at least one bearing. Further, the at least one bamboo may comprise an upper end and a lower end. The at least one bamboo may be configured to hold a plurality of grow cups. Further, at least one composite member may be formed by inserting and fixing at least one rod from at least one end of the at least one bamboo. Further, the at least one composite member may be rotatable, and an upper end of the composite member fixed to an anchor and a lower end of the composite member may be fixed on a mounting surface via the at least one bearing.

In another embodiment, a first rod may be inserted and fixed in the upper end and a second rod may be inserted and fixed in the lower end of the at least one bamboo. Further, the at least one bearing may be attached to at least one end of the at least one composite member. Further, at least one cap may be configured for fixing an outer periphery of the at least one bearing. Further, a first cap may be attached to the upper end of the at least one composite member and further the first cap may be attached to the anchor. Further, a second cap from the at least one cap may be attached to the lower end of the at least one composite member and a second rod may pass through the second cap. Further, the at least composite member may be configured to rotate around vertical axis (Y-Y) in clockwise or anticlockwise direction. Further, the second rod from the lower end of the at least one composite member may be fixed to the mounting surface through the second bearing of the at least one bearing.

Further, the vertical tower may comprise a bunch of composite members. Further, the number of composite members, in the bunch of composite members may vary according to the requirements such as the number and size of the grow cups, required strength of the composite to be attached and the size of the polyhouse structure required. Further, the bunch of composite members may be tied or assembled together using a clamping means. Further, a vertical light channel may be inserted between the bunch of composite members. Further, the vertical light channel comprises a plurality of lighting elements for providing required light intensity to regulate the growth of saplings in a grow cup. Further, the colour of light emitting from the plurality of lighting elements may be varied as per requirement of the saplings. Further, a vertical gas channel may be inserted into the bunch of composite members. Further, the vertical gas channel comprises a plurality of spray nozzles. Further, the vertical gas channel may be configured to spray carbon dioxide, pesticides, herbicides or required medicines to regulate the growth of the saplings in the grow cup.

In yet another embodiment, a central inlet irrigation pipe and a central outlet irrigation pipe may be mounted with the at least one composite member. Further, the central inlet irrigation pipe and the central outlet irrigation pipe comprise a plurality of siphons may be configured to discharge and collect water in the grow cups.

In one aspect of the present invention, a grow cup may comprise an inlet pipe and an outlet pipe. Further, the inlet pipe may be connected with the central inlet irrigation pipe to receive the water and the outlet pipe may be connected with the central outlet irrigation pipe to discharge the extra water. Further, the central inlet irrigation pipe may receive the water from a source of water via pump. Further, the central outlet irrigation pipe may be connected with a collection tank to filter the collected water from the plurality of grow cups. Further, the grow cup, from the plurality of grow cups may comprise a guide and lock mechanism configured to detachably attach the grow cup to the at least one composite member. Further, the grow cup may be configured to attach on the clamping means using the guide and lock mechanism.

In another aspect of the present invention, the at least one composite member may be detachably attached to the polyhouse structure. Further, the polyhouse structure comprises an actuator or a bi-directional motor which may rotate the composite member in desired direction, further, the speed of the actuator or the bi-directional motor may be controlled to achieve desired exposure of sunlight. Further, the composite member may comprise a humidity sensor, a temperature sensor, a speed sensor, a gas sensor, a moisture sensor and a pH sensor to monitor the respective parameters.

### BRIEF DESCRIPTION OF DRAWINGS

The detailed description is described with reference to the accompanying figures. In the Figures, the left-most digit(s) of a reference number identifies the Figure in which the reference number first appears. The same numbers may be used throughout the drawings to refer like features and components.

FIG. 1 illustrates a polyhouse structure (100) with an embodiment of a present subject matter.

FIG. 2 illustrates a vertical tower (120) with an embodiment of a present subject matter.

FIG. 3 illustrates one implementation (200) of the plurality of vertical towers (120) with an embodiment of a present subject matter.

FIGS. 4A, 4B, and 4C illustrate embodiments of the vertical tower (120) with an embodiment of a present subject matter.

FIGS. 5A and 5B illustrate embodiments of the grow cup (300) with an embodiment of a present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification may be not necessarily all referring to the same embodiment. Furthermore, the particular features, structures or characteristics may be combined in any suitable manner in one or more embodiments.

A polyhouse structure for growing multiple saplings may comprise of bamboo. Further, the bamboo may comprise an upper end and a lower end.

In an embodiment, the bamboo may comprise a rod configured to hold a plurality of grow cups. The rod may be a single continuous pole or may comprise one or more sections. In one embodiment, the rod may be inserted and fixed from the upper end till the lower end of the bamboo.

Further, the bamboo may be configured to hold a plurality of grow cups with one or more rods, wherein the one or more rods may be inserted and fixed from the upper end and/or from the lower end of the bamboo. The rod may be a through-and-through member passing through a hollow vertical portion of the bamboo, enable mounting of a bamboo, or pass through a bamboo cladding. The rod may be solid, flexible, hard, soft, or hollow material. The rod may be a metal rod, a plastic fiber rod, a wooden rod.

Further, in an example the bamboo may be configured to hold a plurality of grow cups with the one or more rods selected as metal rods, wherein the one or more metal rods may be inserted and fixed from the upper end and/or from the lower end of the bamboo. The metal rod may be a through-and-through structure passing through a hollow vertical portion of the bamboo.

Further, the bamboo may be configured to hold a plurality of grow cups at least two metal rods wherein a first metal rod may be inserted and fixed in the upper end and a second metal rod may be inserted and fixed in the lower end of the bamboo. In one embodiment, the at least two metal rods may be a single continuous metal rod member inserted and fixed from either of the upper and lower end of the bamboo.

Further, at least one bearing may be attached at both ends of the bamboo shaft. Further, the at least one metal rods may pass through the at least one ball bearing. Further, at least one caps may be configured for fixing an outer periphery of the at least one ball bearing. Further, a first cap may be attached to the upper end of the bamboo and the first cap may be further attached to an anchor using a connecting means. In specific embodiment the first cap may be further attached to an anchor using a flexible cable. Further, a second cap, from the at least two caps, may be attached to the lower end of the bamboo and a second metal rod may pass through the second cap. In another embodiment, a clamping mechanism may be used instead of the metal rods In one embodiment, the metal rods are not limited to above examples and other suitable clamping mechanism are also within the scope of present disclosure.

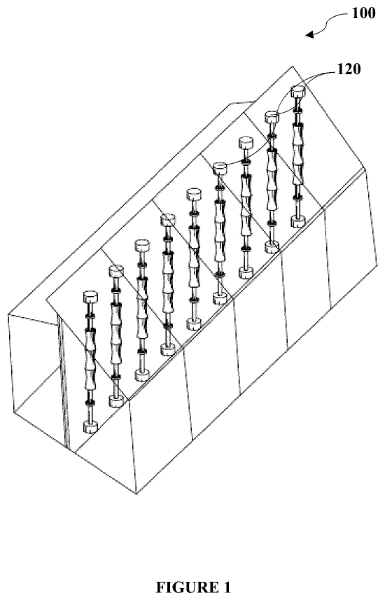

Now referring to FIG. 1 a polyhouse structure 100 for growing multiple saplings may be disclosed. The polyhouse structure 100 may comprise a plurality of vertical towers 120. The plurality of vertical towers 120 may be configured to support polyhouse member. In specific embodiment, the plurality of vertical towers 120 may be configured to support polyhouse roof. The height of the plurality of vertical towers 120 may be variable.

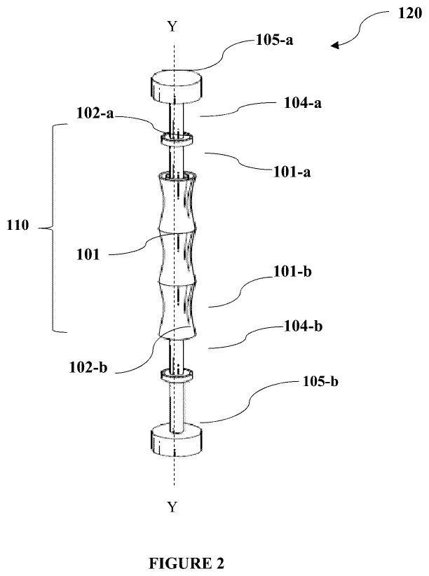

Now referring to FIG. 2 a vertical tower 120, from the plurality of vertical towers 120 may be disclosed. Further, the vertical tower 120 may comprise at least one bamboo 101. Further, the at least one bamboo 101 may comprise an upper end 101-a and a lower end 101-b. Further, the at least one bamboo may be configured to hold a plurality of grow cups 300. Further, the vertical tower 120 may comprise at least one composite member 110. The at least one composite member 110 may be formed by inserting and fixing at least two metal rods 102-a and 102-b at both ends of the at least one bamboo 101. Further, the vertical tower 120 may comprise at least two bearings 104-a,104-b which may make the composite member 110 rotatable. Further, an upper end of the composite member 110 may be fixed to an anchor 106 and a lower end of the composite member 110 may be fixed on a mounting surface (not shown in figures).

The mounting surface may be ground, or a platform specifically constructed as per the spatial requirements of the polyhouse structure 100.

Further, a first metal rod 102-a, from at least two metal rods, may be inserted and fixed in the upper end 101-a and a second metal rod 102-b may be inserted and fixed in the lower end 101-b of the at least one bamboo 101.

Further, the at least two bearings 104-a, 104-b may be attached at both ends of the at least one composite member 110. Further, at least two caps 105-a and 105-b may be configured for fixing an outer periphery of the at least two bearings 104-a and 104-b respectively. Further, a first cap 105-a, from at least two caps, may be attached to the upper end of the at least one composite member 110. Further, the first cap may be attached to an anchor 106, using a wire, cable, rope or any flexible and extendible means. Further, a second cap 105-b may be attached to the lower end of the at least one composite member 110 and the second metal rod 102-b may pass through the second cap 105-b.

Further, the at least one composite member 110 may be configured to rotate around vertical axis Y-Y of the composite member 110, in clockwise or anti-clockwise direction.

Further, the anchor 106 may be installed on a purling of the polyhouse member. Further, the polyhouse may comprise a plurality of anchors.

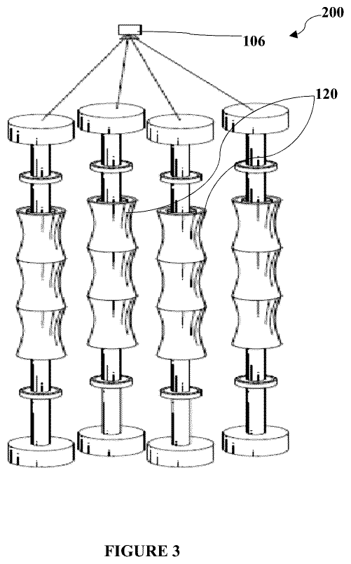

Now referring to FIG. 3, one implementation of the plurality of vertical towers 120 may be disclosed. The plurality of vertical towers 120 may be attached to the anchor 106 by using a cable, wire, rope or any flexible and extendible means. The anchor 106 may serve as a common anchor for the plurality of vertical towers 120. Further, a plurality of anchors may be installed on the puling of the polyhouse structure 100. Further, each anchor 106 from the plurality of anchors may support a plurality of vertical towers 120.

It is also possible to change the design of the composite member 110 according to type of product farmer wants to grow. More specifically, the number of bamboos used in the composite member 110 can be varied.

In one embodiment, the at least one composite member 110 may comprise a bunch of bamboos 200. The number of bamboos, in the bunch of bamboos 200, varies according to requirements such as number and size of the grow cups, required strength of the composite member 110 and the size of polyhouse structure 100 required. The bunch of bamboos 200 may be tied or assembled together using a clamping means 112. The clamping means 112 not only helps in assembling the bunch of bamboos 200 but also helps for mounting the plurality of grow cups 300. In preferred embodiment the clamping means 112 may be a binding ring. Further, the clamping means 112 may be made up of metal wire, metal cables, nylon or any material or required strength. Further, the bamboos may have holes or notched in which the plurality of grow cups may be mounted.

Now let's focus on the conditioning or growth of the saplings in the grow cups 300. For healthy growth of the saplings and high quality of final product it is desirable to control the various parameters of plant growth. These parameters include amount of water, soil moisture, sunlight, medicines, insecticides, pesticides, fertilizers, CO2. Further, soil quality should also be maintained to the required PH level. The soil should not become too acidic or too basic in order to optimize the health of crop. Further, the aeration in the polyhouse should also be maintained to ensure the crops remain healthy and fresh. Further, in case of hydroponics water level in each grow cup at optimum level. Further, in case of aeroponic agriculture, it becomes critical to maintain the humidity of air at desirable level to ensure that the crop remains fresh and does not get dried up due to lack of water. To address all these, the present invention provides various options as follows.

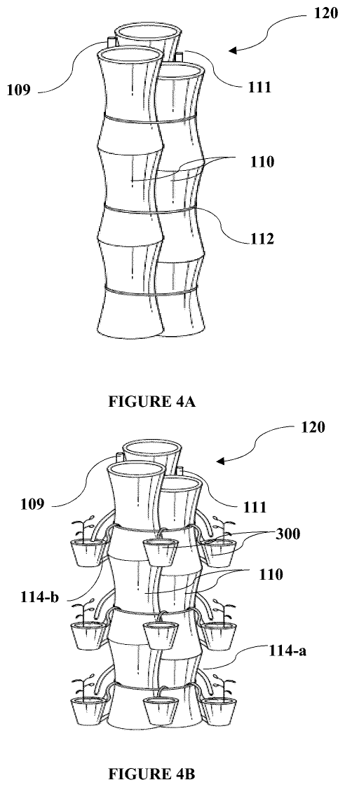

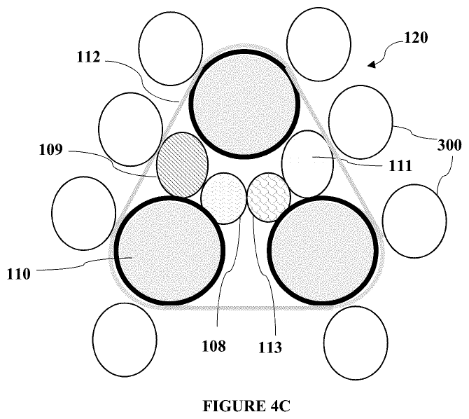

Now referring to FIG. 4A-4C an embodiment of the vertical tower 120 may be disclosed. Further, the vertical tower 120 may comprise a bunch of composite members 110. In the bunch composite members 110, a vertical light channel 109 may be inserted. Further, the vertical light channel 109 may comprise a plurality of lighting elements. The plurality of lighting elements may be configured for providing required light intensity and wavelength to regulate the growth of the saplings in the grow cup 300. Further, the colour of light emitting from the plurality of lighting elements may be varied as per the requirement of the saplings.

Further, a vertical gas channel 111 may be inserted into the bunch of composite members 110. Further, the vertical gas channel 111 may comprise a plurality of spray nozzles. The vertical gas channel 111 may be configured to spray carbon dioxide, pesticides, herbicides or required medicine to regulate the growth of the saplings in the grow cup 300.

Now, focusing on the irrigation of the grow cups 300. FIG. 4C discloses a top view of the vertical tower 120. Further, a central inlet irrigation pipe 108 may be inserted into the vertical tower 120. A water pump (not shown in figures) may be used to fill the central irrigation pipe 108. Further, inlet siphons 114-a may be attached to the central irrigation pipe 108. The inlet siphons 114-a may be configured to discharge water from the central irrigation pipe 108 to individual grow cup. Further, each siphon 114-a may be connected to an inlet pipe 301 of each grow cup 300.

Further, a central outlet irrigation pipe 113 may be inserted into the vertical tower 120. Further, outlet siphons 114-b may be attached to the central outlet irrigation pipe 113. Further, each outlet siphon 114-b may be connected with the outlet pipe 302 of the grow cup. Further, the outlet siphons 114-b may be configured to collect water from each grow cup 300. Further, the outlet siphons 114-b collect all the water into the central outlet irrigation pipe 113. Further, the central outlet irrigation pipe 113 may be connected with a collection tank (not shown in figures). Further, the collection tank may comprise a filter to filter out the impurities from the collected water. Further, the filtered water may again be circulated to the water pump and central inlet irrigation pipe 108. Thus, the water use is minimized, and wastage of water is avoided. Further, the contaminated water may be processed in a water treatment plant before discharging into river or canal thus reducing the water pollution to the minimum.

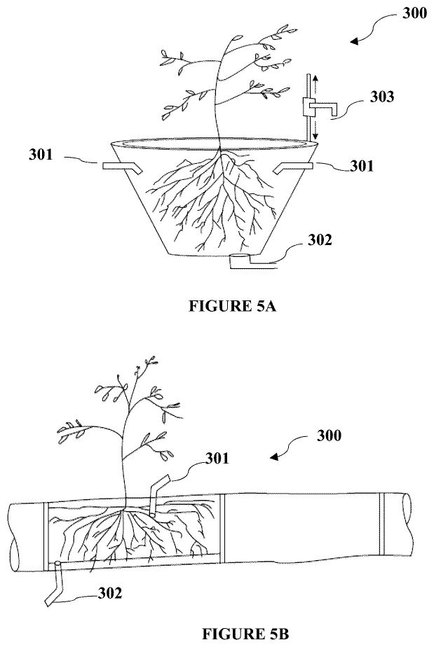

Now referring to FIGS. 5A and 5B, an embodiment of the grow cup 300 is disclosed. The grow cup 300 may comprise an inlet pipe 301. The inlet pipe 301 may be connected with the inlet siphon 114-a. Further, from the inlet siphons 114—the inlet pipe 301 may receive water from the central inlet irrigation pipe 108. Further, the inlet pipe 301 may discharge the received water into the grow cup 300. Further, the grow cup 300 may comprise an outlet pipe 302. The outlet pipe 302 may be further connected to the central outlet irrigation pipe 113 via outlet siphons 114-b. Further, the outlet pipe 302 may be configured to collect the water from the grow cup 300 and discharge into the central outlet irrigation pipe 113.

Further, the grow cup 300 may comprise a guide and lock mechanism 303. The guide and lock mechanism 303 may be configured to detachably attach the grow cup to the composite member 303. Further, the grow cup 300 may be anchored on the clamping means 112 with help of the guide and lock mechanism 303. Further, the composite member 110 may have holes or notches on which the grow cup 300 may be attached.

Further, the shape and size of the grow cups 300 may be varied according to the crop, capacity of the polyhouse and quantity of final produce required. Further, based on the strength of the composite member 110 the size of grow cups may be varied.

Now focussing on the general aspects of the polyhouse structure 100, various arrangements can be made to optimize the overall operation of the polyhouse and ensure minimum human interference. Such arrangements are as follows. The at least one composite member 110 may be detachably attached to the polyhouse structure 100. To ensure the composite member 110 is detachable a sliding mechanism, locking mechanism or snap fit mechanism may be deployed. By virtue of being detachable the fresh produce can be directly taken onto the market without harming the crop. This feature increases the shelf life of the crop and also ensures that consumers get high quality and fresh food sources.

Another arrangement for optimizing the polyhouse operation to control sunlight exposure and aeration in the polyhouse. To facilitate this an actuator or a bi-directional motor may be configured to rotate the composite member 110. Further, the speed of actuator or the bi-directional motor may be controlled to achieve desired exposure of sunlight. By this arrangement equitable distribution of sunlight may be ensured.

Further, in order to continuously monitor various parameters of the crop health sensors may be used such as a humidity sensor, temperature sensor, speed sensor, gas sensor, moisture sensor and pH sensor which monitor respective parameters. Further, the sensors may be communicably connected with a control system. Further, an infrared or thermal camera may be installed to identify pest growth or temperature of the plants inside the polyhouse structure 100. The control system may be configured to receive data from various sensors and transmit orders to various equipment such as motors, water pump to initiate the operation. Further, the control system may generate a data table based on data received from the sensors and send the data table to a user device such as a mobile phone, computer etc. further, a user may initiate action based on the data received from the control system.

In one embodiment, a display device may be installed at each vertical tower 120. The display device may disclose the number of grow cups attached each vertical tower 120. Further, display device may disclose health of each such as vertical tower 120 such as moisture level, watering times, medicines, or carbon dioxide requirements etc expected date of harvest etc.

The embodiments illustrated above, especially related to emergency cut-off valve provide following advantages:
All the parameters of farming are effectively controlled ensuring minimum human interaction.
Inputs such as water, medicines, insecticides, herbicides and fertilizers are optimized ensuring minimum loss of these resources.
Controlled input ensures that the growth of crop remains as natural as possible and ensures that consumers get food free of contaminants.
Optimized design of the vertical tower, the composite member ensures higher density of the production per unit area.
Cycle time of each crop can be regulated as per requirement by controlling various parameters of plant growth.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

The foregoing description shall be interpreted as illustrative and not in any limiting sense. A person of ordinary skill in the art would understand that certain modifications could come within the scope of this disclosure.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

We claim:

1. A polyhouse structure, wherein the polyhouse structure comprising:
a plurality of vertical towers, wherein the plurality of vertical towers support polyhouse member characterized in that a vertical tower of the plurality of vertical towers comprises;
at least one bamboo comprising an upper end and a lower end, wherein the at least one bamboo is configured to hold a plurality of grow cups;
at least one composite member, wherein the at least one composite member is formed by inserting and fixing at least one rod through at least one end of the at least one bamboo and;
at least one bearing, wherein at least one composite member is rotatable, and an upper end of the composite member fixed to an anchor and a lower end of the composite member is fixed on a mounting surface via the at least one bearing.

2. The polyhouse structure as claimed in claim 1, wherein the at least one rod comprises a first metal rod is inserted and fixed in the upper end and a second metal rod is inserted and fixed in the lower end of the at least one bamboo.

3. The polyhouse structure as claimed in claim 1, wherein at least one bearing is attached to at least one end of the at least one composite member.

4. The polyhouse structure as claimed in claim 1, wherein at least one cap configured for fixing an outer periphery of the at least one bearing, wherein a first cap, from at least one cap, is attached to the upper end of the at least one composite member and the first cap is attached to an anchor and;
a second cap from the at least one cap, is attached to the lower end of the at least one composite member and a second metal rod passes through the second cap.

5. The polyhouse structure as claimed in claim 1, wherein the at least composite member is configured to rotate around vertical axis (Y-Y) in clockwise or anticlockwise direction.

6. The polyhouse structure as claimed in claim 1, wherein the anchor is installed on a purling of the polyhouse through the first bearing of the at least one bearing.

7. The polyhouse structure as claimed in claim 1, wherein the second metal rod from the lower end of the at least one composite member is fixed to the mounting surface through the second bearing of the at least one bearing.

8. The polyhouse structure as claimed in claim 1, wherein the vertical tower comprises a bunch of composite members, wherein the number of composite members, in the bunch of composite members, varies according to the requirements, wherein the requirements includes the number and size of the grow cups, required strength of the composite to be attached and the size of the polyhouse structure required.

9. The polyhouse structure as claimed in claim 1, wherein the bunch of composite members are tied or assembled using a clamping means.

10. The polyhouse structure as claimed in claim 1, wherein a vertical light channel is inserted between the bunch of composite members, wherein the vertical light channel comprises a plurality of lighting elements for providing required light intensity to regulate the growth of saplings in a grow cup, wherein the colour of light emitting from the plurality of lighting elements are varied as per requirement of the saplings.

11. The polyhouse structure as claimed in claim 1, wherein a vertical gas channel is inserted into the bunch of composite member, wherein the vertical gas channel comprises a plurality of spray nozzles, wherein the vertical gas channel is configured to spray carbon dioxide, pesticides, herbicides or required medicines to regulate the growth of the saplings in the grow cup.

12. The polyhouse structure as claimed in claim 1, wherein a central inlet irrigation pipe and a central outlet irrigation pipe are mounted with the at least one composite member, wherein the central inlet irrigation pipe and the central outlet irrigation pipe comprise a plurality of siphons configured to discharge and collect water in the grow cups.

13. The polyhouse structure as claimed in claim 1, wherein a grow cup from the plurality of grow cups, comprises an inlet pipe and an outlet pipe, wherein the inlet pipe is connected with the central inlet irrigation pipe to receive the water and the outlet pipe is connected with the central outlet irrigation pipe to discharge the extra water.

14. The polyhouse structure as claimed in claim 1, wherein the central inlet irrigation pipe receives the water from a source of water via pump.

15. The polyhouse structure as claimed in claim 1, wherein the central outlet irrigation pipe is connected with a collection tank to filter the collected water from the plurality of grow cups.

16. The polyhouse structure as claimed in claim 1, wherein the grow cup, from the plurality of grow cups, comprises a guide and lock mechanism configured to detachably attach the grow cup to the at least one bamboo.

17. The polyhouse structure as claimed in claim 1, wherein the grow cup, from the plurality of grow cups, is configured to attach on the clamping means using the guide and lock mechanism.

18. The polyhouse structure as claimed in claim 1, wherein the at least one composite member is detachably attached the polyhouse structure.

19. The polyhouse structure as claimed in claim 1, wherein the polyhouse structure comprises an actuator or a bi-directional motor to rotate the composite member in desired direction, wherein the speed of the actuator or the bi-directional motor is controlled to achieve desired exposure of sunlight.

20. The polyhouse structure as claimed in claim 1, wherein the composite member comprises a humidity sensor, a temperature sensor, a speed sensor, a gas sensor, a moisture sensor and a pH sensor to monitor the respective parameters.
